(19) United States
(12) Patent Application Publication
(10) Pub. No.: US 2007/0028947 A1
(43) Pub. Date: Feb. 8, 2007

(54) GAS TURBINE ON-LINE COMPRESSOR WATER WASH SYSTEM

(75) Inventors: Dean Matthew Erickson, Simpsonville, SC (US); Gerald Wilson Grove, Simpsonville, SC (US); Iris Ziqin Hu, Greer, SC (US); Matthew Scott Kight, Greenville, SC (US); Lane Porter, Simpsonville, SC (US); Carl Gerard Schott, Simpsonville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/161,469

(22) Filed: Aug. 4, 2005

(51) Int. Cl. B08B 3/02

(52) U.S. Cl. 134/22.18; 134/198; 134/166 R; 134/169 A; 134/22.1

(57) ABSTRACT

An on-line water wash system for a compressor having a bellmouth casing with a region of known high velocity inlet airflow and a number of rotating blades. The water wash system may include a number of water nozzles positioned within the bellmouth casing about the region of known high velocity inlet airflow and a stream of water droplets. The stream of water droplets is targeted by the water nozzles so as to avoid the bellmouth casing and the rotating blades.

### TECHNICAL FIELD

The present application relates generally to gas turbines engines and more particularly relates to an improved on-line compressor water wash system for gas turbine engines.

### BACKGROUND OF THE INVENTION

An on-line water wash system is commonly used to remove contaminants from gas turbine compressors. The on-line system recovers gas turbine efficiency when the operating schedule does not permit shutdown time so as to perform a more effective off-line wash. For example, U.S. Pat. No. 5,011,540 to McDermott describes a commonly used on-line water wash system. The nozzles of the system are located in positions upstream or directly at the inlet to the compressor bellmouth casing. These nozzles create a spray mist of water droplets within a region of relatively low velocity air. When in operation, the spray mist is drawn through the bellmouth and into the compressor inlet by the negative pressure produced by the rotating compressor.

This known system, however, does not address the specific travel path of the mist droplets. As a result of this, erosion of the first stage rotating blade may occur at undesirable locations along the leading edge of the blade, including the root region. If erosion pits caused by the droplets exceed a critical flaw size, a total failure of the blade may occur. To prevent this event, monitoring of wash hours along with a blade inspection and repair program may be needed. These requirements, however, are time consuming and costly.

There is a desire, therefore, for an on-line water wash system that eliminates or reduces first stage rotor blade root erosion while still providing effective cleaning of the turbine compressor. It is preferred that the resultant cleaning will be as effective, if not more effective, then commonly known systems.

### SUMMARY OF THE INVENTION

The present application describes an on-line water wash system for a compressor having a bellmouth casing with a region of known high velocity inlet airflow and a number of rotating blades. The water wash system may include a number of water nozzles positioned within the bellmouth casing about the region of known high velocity inlet airflow and a stream of water droplets. The stream of water droplets is targeted by the water nozzles so as to avoid the bellmouth casing and the rotating blades.

The water nozzles include a number of aft side water wash nozzles. The bellmouth casing includes an inlet and the water nozzles are positioned between the inlet and the rotating blades. The water nozzles may be aft nozzles. The compressor also may include a number of struts. The water nozzles may be positioned between the struts. There may be a nozzle for each pair of the struts. The stream of water droplets is targeted by the water nozzles so as to avoid wetting the struts. A pressure regulating valve may be in communication with the nozzles.

The present application further describes a method of on-line washing of a turbine having a compressor with an air inlet pathway for a high velocity air stream defined by a bellmouth casing and leading to a number of rotating blades. The method may include the steps of determining the location of the high velocity air stream, targeting the location of the high velocity air stream with a spray of water droplets, and providing the spray of water droplets to the location of the high velocity air stream such that the spray of water droplets stays in the air inlet pathway instead of coating the bellmouth casing or the rotating blades.

The compressor also may have a number of struts. The method further may include the step of providing the stream of water droplets such that the spray of water droplets stays in the air inlet pathway instead of coating the struts.

The present application further describes an on-line water wash system for a compressor having a bellmouth casing with a region of known high velocity inlet airflow, a number of rotating blades, and a number of struts. The water wash system may include a number of water nozzles positioned within the bellmouth casing, between a pair of the struts, and about the region of known high velocity inlet airflow. The water wash system includes a stream of water droplets. The stream of water droplets is targeted by the water nozzles so as to avoid the bellmouth casing, the rotating blades, and the struts.

These and other features of the present invention will become apparent to one of ordinary skill in the art upon review of the following detailed description of the embodiments when taken in conjunction with the drawings and the appended claims.

### BRIEF DESCRIPTION OF THE DRAWINGS

FIG. 1 is a side cross-sectional view of a known water wash system positioned upstream of a bellmouth casing inlet of a compressor.

FIG. 2 is a perspective view of a water manifold system of the water wash system of FIG. 1.

FIG. 3 is a side cross-sectional view of a water wash system as is described herein and positioned downstream of a bellmouth casing inlet of a compressor.

FIG. 4 is a perspective view of a water manifold system of the water wash system of FIG. 3.

### DETAILED DESCRIPTION

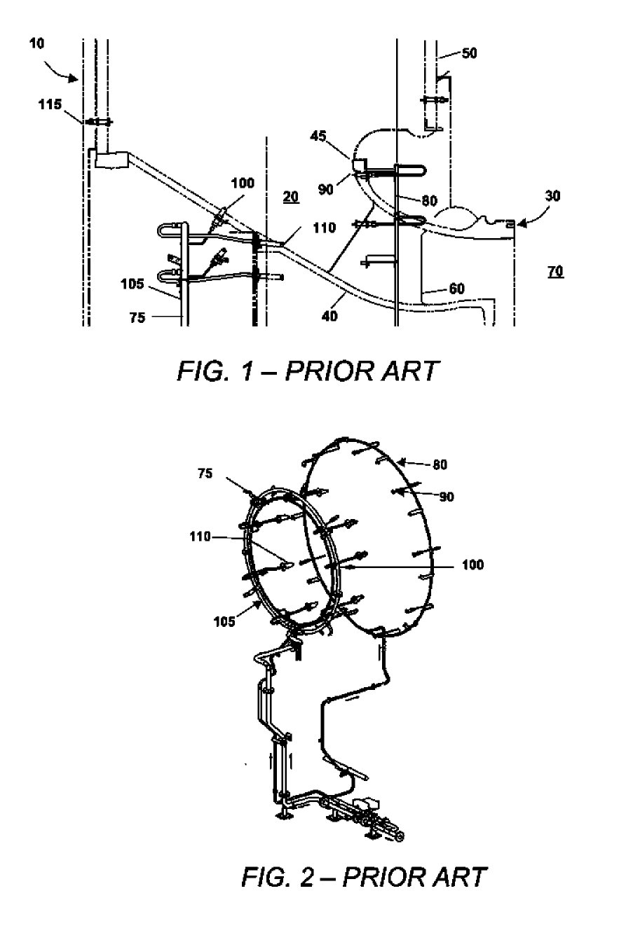

Referring now to the drawings, in which like numerals refer to like elements throughout the several views, FIGS. 1 and 2 show an example of a known water wash system 10. The nozzles of the water wash system 10 are positioned about an air inlet pathway 20 of a compressor 30. Generally described, the air inlet pathway 20 of the compressor 30 is defined by a bellmouth casing 40 in communication with an inlet plenum 50. The bellmouth casing 40 includes an inlet 45 adjacent to the inlet plenum 50. The air inlet pathway 20 then leads past a number of bellmouth struts 60 and into a number of rotating blades 70 of the compressor 30.

As shown in FIG. 2, the on-line water wash system 10 includes a number of independent supply manifolds, a forward manifold 75 and an aft manifold 80. Each manifold supplies water to a number of corresponding nozzles, a number of aft nozzles 90 and a number of forward nozzles 100. This arrangement is similar to that shown in U.S. Pat. No. 5,011,540 to McDermott, incorporated herein by reference. The overall water wash system 10 also may include an independent manifold 105 and nozzles 110 utilized for off-line water washing. Other up stream nozzles 115 also may be used herein.

As is described above, both sets of nozzles 90 and 100 produce a spray mist of water droplets that are drawn into the air inlet pathway 20 by the negative pressure created by the rotating compressor blades 70. In traveling along the air inlet pathway 20, some droplets may strike the inside diameter wall of the bellmouth casing 40 and/or the bellmouth struts 60. A high concentration of these droplets may strike the root of the first stage rotating blades 70. The nozzles 90, 100, 115 described herein thus provide minimum targeting capability and, hence, less effective cleaning and possibly significant damage to the blades 70.

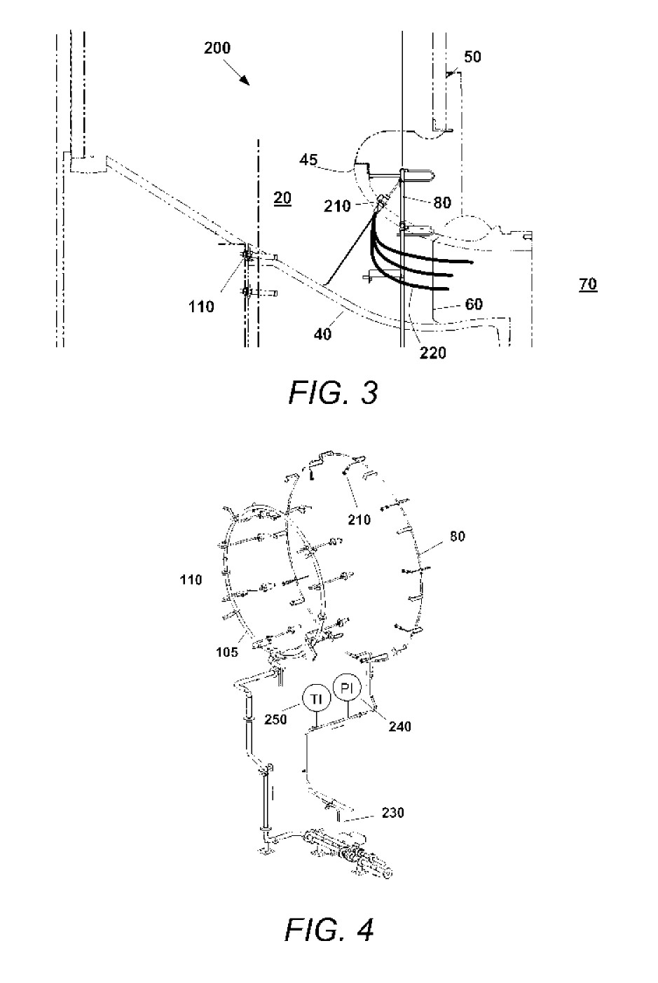

FIGS. 3 and 4 show a water wash system 200 as is described herein. In this water wash system 200, the forward on-line water wash nozzles 100 have been eliminated and the aft on-line water wash nozzles 90 have been redesigned and moved to a new location. The new aft nozzles 210 are positioned downstream from the former position of the aft side nozzles 90 of the known water wash system 10. Specifically, the aft side nozzles 210 are positioned about the air inlet pathway 20 within the bellmouth casing 40 and in between the bellmouth struts 60. The nozzles 210 may be installed in holes that are machined into the walls of the casing 40. The number of nozzles 210 may equal to or exceed the number of struts 60 or pairs of struts 60. Single or multiple nozzles 210 can be installed between each set of adjacent struts 60.

The nozzles 210 are positioned in a region of known high inlet air velocity where analysis and testing has confirmed that the spray mist efficiently enters the air inlet pathway 20 of the compressor 30. The specifics of the air velocity regions can be determined by aerodynamic modeling of the air inlet pathway 20, the inlet plenum 50, and the bellmouth casing 40. The positioning minimizes wetting of the walls of the bellmouth casing 40 and the struts 60 and reducing the amount of water reaching the root of the first stage blades 70.

Functionally, the aft side nozzles 210 are located about a position that provides targeting capability into the compressor air inlet pathway 20. The position about the high inlet air velocity results in the ability to optimize the direction of a spray of water droplets 220. Optimal spray coverage is defined as a full radial distribution of the spray droplets 220, with the exception of the roots of the blades 70. Actual targeting is achieved with consideration of the nozzle pressure ratio, the injection angles, and the nozzle tip design. As such, the vast majority of the spray droplets 220 remain in the free airflow path within the compressor air inlet pathway 20.

Both the size and the velocity profile of the spray droplets 220 will vary as the inlet velocity changes. With inlet air velocity being directly related to the geometry of the compressor 30 and the inlet air inlet pathway 20, the optimum design of the system 200 should be analyzed and defined for each specific gas turbine model. This optimization can achieved by system modeling, including computational fluid dynamics (CFD) and full scale wind tunnel (rig) testing. Velocity also may vary with ambient operating conditions, turbine loads, and other operating parameters.

With water supply pressure being a contributor to the nozzle pressure ratio, the system 200 also may include a pressure-regulating valve 230 and local pressure gauge 240 to insure that the pressure is maintained as desired level. A pressure transducer 250 also may be utilized.

It should be apparent that the foregoing description relates only to the preferred embodiment of the present invention and that numerous changes and modifications may be made herein without departing from the general spirit and scope of the invention as defined by the following claims and the equivalents thereof.

What is claimed is:

1. An on-line water wash system for a gas turbine compressor having a bellmouth casing with a region of known high velocity inlet airflow and a plurality of rotating blades, comprising:
a plurality of water nozzles positioned within the bellmouth casing and about the region of known high velocity inlet airflow; and
a projected stream of water droplets;
the stream of water droplets is targeted by the plurality of water nozzles so as to avoid wetting of the bellmouth casing and the plurality of rotating blades.

2. The on-line water wash system of claim 1, wherein the plurality of water nozzles comprises a plurality of aft side water nozzles.

3. The on-line water wash system of claim 1, wherein the bellmouth casing includes an inlet and wherein the plurality of water nozzles are positioned between the inlet and the plurality of rotating blades.

4. The on-line water wash system of claim 1, further comprising a pressure regulating valve in communication with the plurality of nozzles.

5. The on-line water wash system of claim 1, wherein the compressor further includes a plurality of struts and wherein the plurality of water nozzles are positioned between pairs of the plurality of struts.

6. The on-line water wash system of claim 5, wherein the plurality of water nozzles comprises a nozzle for each pair of struts.

7. The on-line water wash system of claim 5, wherein the plurality of water nozzles comprises a plurality of nozzles for each pair of struts.

8. The on-line water wash system of claim 5, wherein the stream of water droplets is targeted by the plurality of water nozzles so as to avoid wetting the plurality of struts.

9. A method of on-line washing of a turbine having a compressor with an air inlet pathway for a high velocity air stream defined by a bellmouth casing and leading to a number of rotating blades, comprising:
determining the profile of the high velocity air stream;
targeting the location of the high velocity air stream with a spray of water droplets; and
providing the spray of water droplets to the location of the high velocity air stream such that the spray of water droplets stays in the air inlet pathway instead of coating the bellmouth casing walls or the number of rotating blades.

10. The method of claim 9, wherein the compressor further includes a plurality of struts and wherein the method further comprises providing the stream of water droplets such that the spray of water droplets stays in the air inlet pathway instead of coating the plurality of struts.

11. An on-line water wash system for a gas turbine compressor having a bellmouth casing with a region of known high velocity inlet airflow, a plurality of rotating blades, and a plurality of struts, comprising:
a plurality of water nozzles positioned within the bellmouth casing, between a pair of the plurality of struts, and about the region of known high velocity inlet airflow; and
a projected stream of water droplets;
the stream of water droplets is targeted by the plurality of water nozzles so as to avoid wetting of the bellmouth casing, the plurality of rotating blades, and the plurality of struts.
